(19) United States
(12) Patent Application Publication
(10) Pub. No.: US 2016/0301992 A1
(43) Pub. Date: Oct. 13, 2016

(54) ELECTRONIC CASTER SYSTEM FOR A FURNITURE COMPONENT

(71) Applicant: TOME, INC., Royal Oak, MI (US)

(72) Inventors: Eric Christoper BARCH, Oxford, MI (US); Jacob R. SIGAL, Ferndale, MI (US)

(21) Appl. No.: 15/013,379

(22) Filed: Feb. 2, 2016

Related U.S. Application Data
(60) Provisional application No. 62/145,312, filed on Apr. 9, 2015.

(51) Int. Cl. H04Q 9/00; B60B 33/00

(52) U.S. Cl. CPC H04Q 9/00; B60B 33/00; H04Q 2209/40

(57) ABSTRACT

The present disclosure relates to a system for monitoring usage of a furniture component. The system uses a gateway communications module disposed in an area in proximity to the furniture component. A caster is used to at least partially support the furniture component, and has an electronic component for sensing at least one of weight or motion of the caster. The caster also has a wireless electronic radio for wirelessly communicating with the remote gateway communication module. A remote management system receives information from the gateway communications module, in real time, and uses the information to determine if the furniture component associated with the caster is in use. A central management/monitoring system is in communication with the remote management subsystem, and receives information from the remote management subsystem as to a real time status of use of the furniture component.

### CROSS-REFERENCE TO RELATED APPLICATIONS

This application claims the benefit of U.S. Provisional Application No. 62/145,312, filed on Apr. 9, 2015. The entire disclosure of the above application is incorporated herein by reference.

### FIELD

The present disclosure relates to casters typically used with chairs, beds and other furniture items that occasionally need to be rolled about, and more particularly to an electronic caster system which is attached to a specific furniture component, and which can operate in connection with a plurality of other furniture components making use of the same electronic caster, and further where all of the casters are able to report to a central management system for the purpose of enabling the central management system to monitor overall usage and utilization of all of the furniture components.

### BACKGROUND

The statements in this section merely provide background information related to the present disclosure and may not constitute prior art.

The ability to monitor real time usage and availability of office desks, conference rooms, etc., has proven challenging. This is especially so with large office facilities. With large office facilities, there may be conference rooms or user work desks spread out over a large area.

The ability to monitor and track real time usage of such work desks and/or chairs within each conference room would provide valuable assistance to an entity in maximizing its furniture resources. Any system that could alert workers to the locations of available work desks, conference rooms, in real time fashion, would be especially useful and valuable. Being able to provide a running, real time utilization of all available desks, chairs and conference rooms in a large office setting would also be highly valuable.

The ability to be able to monitor real time usage of chairs and other furniture components such as beds would also be highly valuable in alerting management that an individual or patient is not present in her/his bed at a given time. In other applications, it may be highly valuable to monitor time spent by a patient in a bed for purposes of ensuring that the patient is being sufficiently ambulatory. In a convalescent/nursing facility environment, these abilities would be especially valuable.

### SUMMARY

In one aspect the present disclosure relates to a system for monitoring usage of a furniture component. The system may comprise a gateway communications module disposed in an area in proximity to the furniture component. A caster may be included which has an electronic component for sensing at least one of weight or motion of the caster. The caster may be used to at least partially support a furniture component. The caster may also include a wireless electronic radio for wirelessly communicating with the remote gateway communication module. A remote management system may be included which is configured to receive information from the gateway communications module, in real time, and to use the information to determine if the furniture component associated with the caster is in use. A central management/monitoring system may also be included which is in communication with the remote management subsystem. The central management/monitoring system may be configured for receiving information from the remote management subsystem as to a real time status of use of the furniture component.

In another aspect the present disclosure relates to a system for monitoring usage of a plurality of furniture components. The system may comprise a gateway communications module disposed in an area in proximity to the furniture components. A plurality of casters may be included, with each caster being associated with a different furniture component. Each one of the casters may include an electronic component for sensing at least one of weight or motion of the caster. The caster may be used to at least partially support its associated furniture component. Each one of the casters further may include a wireless electronic radio for wirelessly communicating with the gateway communication module and providing information concerning occupancy of its associated furniture component. A cloud based remote management system is configured to receive information from the gateway communications module in real time, and to use the information to determine if the furniture component associated with the caster is in use. A central management/monitoring system may also be included which is in communication with the remote management subsystem. The central management/monitoring system may be configured for receiving information from the remote management subsystem as to a real time status of use of the furniture component.

In still another aspect the present disclosure relates to a method for monitoring usage of a furniture component. The method may comprise providing a gateway communications module disposed in proximity to the furniture component, and using a caster to at least partially support the furniture component. The method may further involve configuring the caster to include an electronic component within a housing of the caster for sensing at least one of weight or motion of the caster in real time. A wireless electronic radio may be used which is disposed in the housing of the caster for wirelessly communicating with the remote gateway communications module. A remote management system may be used which is configured to receive information from the gateway communications module in real time, and to use the information to determine if the furniture component associated with the caster is in use. A central management/monitoring system may also be placed in communication with the remote management subsystem for receiving information from the remote management subsystem as to a real time status of use of the furniture component.

### BRIEF DESCRIPTION OF THE DRAWINGS

The drawings described herein are for illustration purposes only and are not intended to limit the scope of the present disclosure in any way.

FIG. 1 is a high level block diagram of one embodiment of a system in accordance with the present disclosure for real time monitoring and management of the usage of a plurality of furniture components each having an electronic caster, and wherein each electronic caster communicates with a central gateway for the purpose of enabling real time monitoring and usage the furniture components associated with the casters; and

FIG. 2 is a flowchart illustrating various operations that the system of FIG. 1 may perform during its operation.

### DETAILED DESCRIPTION

The following description is merely exemplary in nature and is not intended to limit the present disclosure, application, or uses. It should be understood that throughout the drawings, corresponding reference numerals indicate like or corresponding parts and features.

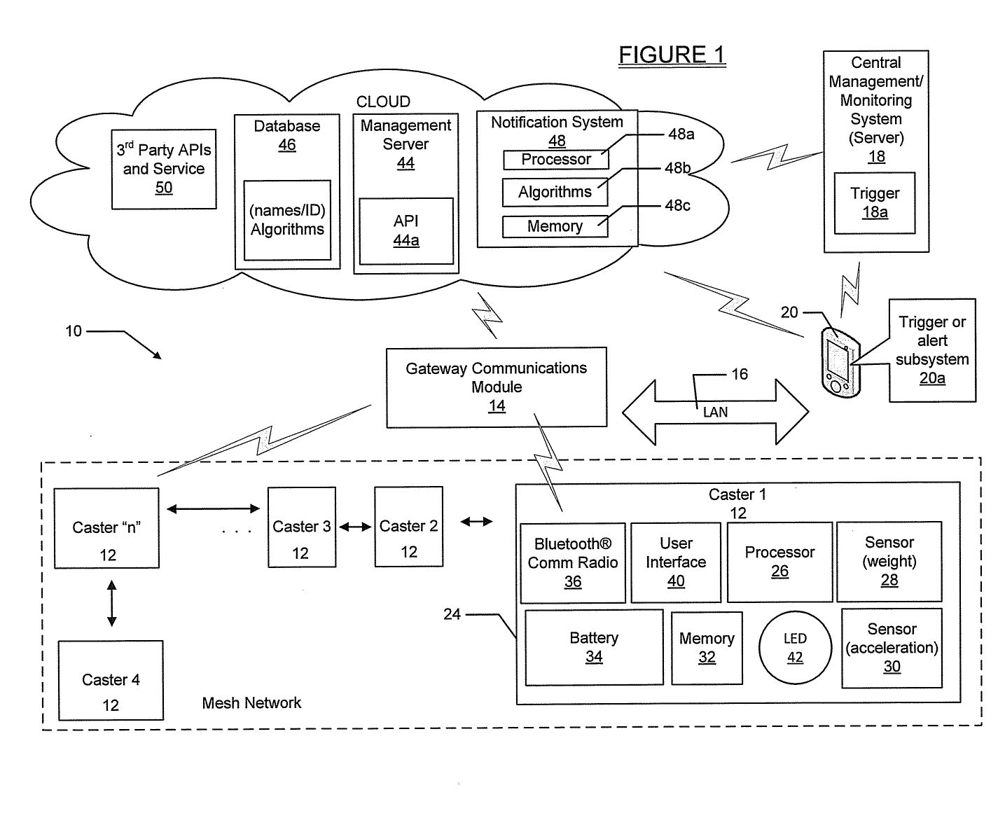

Referring to FIG. 1, there is shown a system 10 for monitoring and managing a plurality of furniture components. The system 10 makes use of a caster system 12 in accordance with the present teachings which may be provided with the furniture component when the furniture component is initially sold, or alternatively the caster system 12 may be constructed so as to be retrofittable to a specific furniture component model made by a specific manufacturer. In one example the furniture component may be a chair. In another example the furniture component may be a bed. Still other examples of furniture components are tables. The caster system 12 of the present disclosure could be used with virtually any furniture component that makes use of casters for support and movement. And while most furniture components typically require the use of four or more casters, it will be appreciated that only one of the caster systems 12 needs to be implemented on a given furniture item to be able to monitor usage of the furniture item.

FIG. 1 illustrates a plurality of caster systems 12 being used in the system 10. Virtually any number of caster systems 12 may be employed. It will be appreciated that while four or more casters may be used on a given furniture component, only one caster system 12 needs to be used with the furniture component to be able to detect a change in weight and/or motion of the component, as will be described further in the following paragraphs.

Each caster system 12 may be in wireless communication with one or more other nearby caster systems 12, and one or more designated caster systems 12 may act to relay information, in real time or at set periodic time intervals, from adjacently located caster systems 12 which it is in communication with, to a gateway communications module 14. Alternatively, one or more of the caster systems 12, or all of the caster systems 12, may communicate directly with the gateway communications module 14. A LAN 16 (which may be a wireless LAN), may communicate directly with the gateway communications module 14 or alternatively with a central management/monitoring system 18.

The gateway communications module 14 or the central management/monitoring system 18 may communicate with one or more cloud-based subsystems to report information associated with the usage of the caster systems 12. The cloud-based subsystems may report back to the central management/monitoring system 18 and/or to a personal electronic device 20, such as a smartphone, tablet, laptop, desktop, etc. The caster system 12 may have a housing 24 with one or more wheels and an internal compartment which houses one or more electronic components formed on one or more small circuit boards. The electronic components may include a processor 26, a weight sensor 28, an acceleration sensor 30, a memory 32 such as a flash memory or a non-volatile memory, a battery 34, a Bluetooth® wireless short range communications protocol radio 36 (or alternatively a ZigBee® wireless communications protocol transceiver), which may be configured to operate in a mesh configuration or a non-mesh configuration, and an optional user interface 40. The processor 26 may have internal ROM (not shown) which is hard coded with an identification code that unique identifies the caster system 12 to the gateway communications module 14. If the optional user interface 40 is provided, this could be formed by a miniature panel of a plurality of switches that can be set to provide a user designated code that the processor 26 uses when its communicates with the gateway communications module 14. The housing 24 may incorporate a removable wall or cover member that allows access to the battery 34 and/or to the user interface 40. The housing 24 may also incorporate an LED 42 which functions as a status indicator that the caster system 12 is operable and is powered on. If the LED 42 is turned off, this may indicate to the user that the battery 34 needs replacing. The processor 26 could also implement a flashing On/Off condition for the LED 42 if the battery power drops below a predesignated value (e.g., below 10%).

If it is desired that the casters 12 are part of a mesh network, then a Bluetooth® protocol low energy mesh network may be implemented, or alternatively a SmartMesh wirelessHART mesh network may be implemented. In either type of mesh network, each caster system 12 would essentially function as a “node” of the mesh network, and would be able to receive wireless signals from adjacent caster systems 12 within a predetermined radius. Each caster system 12 may communicate directly with the gateway communications module 14 or, if it is at too great a distance from the gateway communications module 14, its transmissions may be relayed by one or more adjacent nodes and reported to the module 14. The cloud based systems may include a management server 44 having a suitable API 44a running thereon for interpreting and managing the real time data received from all the caster systems 12. The API 44a may be used by the personal electronic device 20 to retrieve usage statistics and to receive notifications. A database 46 may be independent of, or integrated with, the management server 44. The database 46 may contain names, identification codes, algorithms for interpreting received data and/or generating real time utilization information use for an organization or entity. A notification system 48 may be independent of or integrated with the management server 44. The notification system 48 may be on a server in the cloud and may have a processor 48a, various algorithms 48b needed for analyzing the received information to generate triggers or alerts, and a suitable memory 48c (RAM or ROM). The notification system 48 may be used to generate messages and real time utilization information (e.g., reports) that is communicated either to the central management/monitoring system 18 or to the PED 20 of a given user. Optionally, third party APIs and services 50 may also be in communication with the management server 44. Such third party services may be health related entities, such as a health insurance companies, that would find the data produced by the system 10 useful.

The central management/monitoring system 18 may include a “trigger” or alert subsystem 18a which identifies when the furniture components associated with a specific caster system 12 experiences an event. The trigger or alert subsystem 18a may be an API provided by a server associated with the central management/monitoring system 18. By “event”, it is meant some action that would be useful for the entity operating the central management/monitoring system 18 to recognize. An “event” could be a specific chair at a desk becoming unoccupied, or being occupied. Likewise, an “event” may represent a specific bed becoming occupied or becoming unoccupied. Still further, an event could be a notification that a specific bed or chair has been occupied for more than one hour. This information could be conveyed to a user in any number of ways, such as generating a pop-up notification on a display screen or by highlighting those furniture items presented in a list of furniture components where no individual is sensed as being seated or laying on the furniture component. Optionally, a similar trigger or alert subsystem 20a, for example an API, may be used on a user's PED 20.

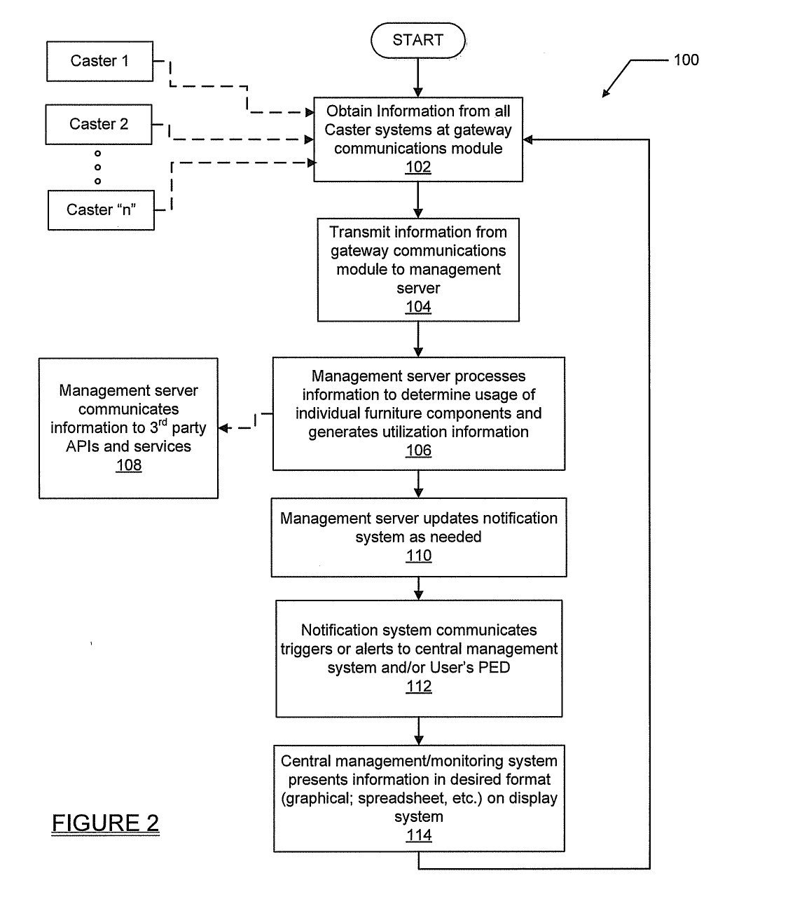

Referring to FIG. 2 a flowchart 100 is shown illustrating various operations that are performed by the system 10. At operation 102 each of the caster systems 12 reports its information to the gateway communications module 14. The information may indicate that a person is presently sitting (or lying) on a furniture component such as a chair or bed. As such, the information may represent a weight that the caster system 12 is sensing or possibly movement such as an acceleration of the caster. This information may be transmitted using the Bluetooth® protocol communications radio 36 to the gateway communications module 14 or possibly to nearby casters 12 which act as nodes to relay the information to the module 14, as indicated at operation 104.

At operation 106 the management server 44 processes the information to determine usage of individual furniture components and generates information on availability or utilization. The information may be presented in any suitable format on a display screen such as in a grid of icons, with each icon representing a single furniture component (e.g., chair or bed) and with different colors indicating which furniture components are presently occupied and which are presently unoccupied. The furniture components can be further segregated into distinct groups in the display format, for example to represent all of the chairs at work desks in a first given area of an office, and a second group representing chairs in a specific conference. Thus, the user may be provided, at a glance, with the availability of furniture components in different areas of an office building. In a health care setting, the display may be segregated into floors or even departments (e.g., pediatrics, cardiology, etc.) within a given floor, with the beds in each in each floor/department indicated by an icon that is highlighted with a first color to indicate “occupied” and a second color to indicate “unoccupied”.

At operation 108, an optional operation may be performed by which the management server 44 communicates information on furniture component usage or overall utilization to a third party API or a third party service. Such a service could be a health care provider or any other type of entity that would find the information useful.

At operation 110 the management server 44 updates the notification system 48 as needed. The notification system may be used to analyze the received information and to provide triggers or alerts to the central management/monitoring system 18 when a specific condition is met. Such a trigger or alert may be generated if a furniture component becomes available for use, or if a specific furniture component has been detected as being unoccupied for a minimum time period. This another trigger or alert may be provided if a hospital bed becomes unoccupied for a given amount of time, such as more than ten minutes. In a health care setting this may be valuable to provide health care workers that a patient who has left her/his bed has not returned after a predetermined time period. This can help health care workers more quickly detect that a patient may have fallen in a bathroom area, or may otherwise be in a position where help is needed.

At operation 112 the notification system 48 communicates any triggers or alerts to the central management/monitoring system 18 and/or to the user's PED 20. The central management/monitoring system 18 may also use its own trigger or alert subsystem 18a to provide additional alerts to certain conditions having arisen. Likewise, the trigger 20a running on the user's PED 20 could be used to provide alerts or other notifications of specific conditions having arisen. Such alerts or notifications could be provided via email, text message, or any other suitable means.

At operation 114 the central management/monitoring system 18 may present the information in a desired format to a suitable display device, for example a display monitor (e.g., LED, not shown). If the PED 20 is being used to receive the information, then the information could be formatted in a suitable way to make same easily read and understood on the relatively small display associated with many PEDs.

It will be appreciated that the operations 102-114 are preferably performed in real time using real time information obtained from the caster systems 12. It will also be appreciated that implementing the caster systems 12 may involve performing a calibration operation by which each caster system 12 “learns” the unoccupied weight of the furniture component that it is used with. In this manner, when a user sits or lays down on a furniture component which has incorporated one of the caster systems 12, the caster system 12 will be able to detect the sudden change in weight and provide a signal indicating the presence or absence of an individual. In this regard the calibration essentially informs the caster system 12 what “unoccupied” weight it will sense when no user is present sitting in, or lying on, the furniture component. The calibration procedure may also involve setting a “minimum” weight that will be recognized as a person. Thus, if someone sets a back pack on a furniture component, where the backpack weighs maybe 25 pounds, the caster system 12 would not mistakenly detect that an individual has sat (or laid) down on its associated furniture component, which in this example would be a chair or a bed. The calibration may be accomplished by setting a switch on the user interface 40 to place each caster system 12 into a calibration mode for a predetermined time period, which enables the caster system 12 to sense a “normal” or “unoccupied” weight using sensor 28, of its associated furniture item, and then switching off the calibration mode after the predetermined time period has expired.

The various embodiments of the system 10 as described herein provide a means by which a large number of furniture components such as, but not limited to, chairs, beds, tables, etc., can be monitored, in real time, to determine if same are in use. The various embodiments also provide a means to collect data from a large number of electronic caster systems 12 and to use the data to provide real time utilization information to a user as to exactly which furniture components are in use at any given time. This can significantly help to manage usage of workstations and conference rooms in office facilities. In a health care environment, the real time utilization information generated by the system 10 can be used to monitor bed availability or even whether patients have left their beds, or if patients have been in their beds continuously for more than a prescribed time period. This can be extremely useful for health care workers and may provide a means by which health care workers can remotely monitor patient activity.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A system for monitoring usage of a furniture component, the system
comprising:
a gateway communications module disposed in an area in proximity to the furniture component;
a caster including an electronic component for sensing at least one of weight or motion of the caster, the caster being used to at least partially support a furniture component;
the caster including a wireless electronic radio for wirelessly communicating with the remote gateway communication module; and
a remote management system configured to receive information from the gateway communications module in real time and to use the information to determine if the furniture component associated with the caster is in use; and
a central management/monitoring system in communication with the remote management subsystem for receiving information from the remote management subsystem as to a real time status of use of the furniture component.

2. The system of claim 1, wherein the furniture component comprises one of:
a chair;
a bed; or
a table.

3. The system of claim 1, wherein the caster further includes:
a battery;
a processor;
a memory; and
a weight sensor.

4. The system of claim 1, wherein the caster further includes:
a battery;
a processor;
a memory; and
an acceleration sensor.

5. The system of claim 1, wherein the management system comprises a cloud based management system.

6. The system of claim 5, further comprising a cloud based database including at least one of names, identification codes or algorithms for use in analyzing and interpreting the information received by the management system.

7. The system of claim 5, further comprising a cloud based notification system for providing notification alerts to the central management system relating to at least one of events or a status of the furniture component.

8. The system of claim 7, wherein the cloud based notification system includes:
a processor;
at least one algorithm; and
a memory.

9. The system of claim 1, wherein the gateway communications module is in wireless communication with the management system.

10. The system of claim 1, wherein the management system includes an application programming interface (API) for interpreting and managing real time data generated from the information received from the gateway communications module.

11. The system of claim 1, wherein the caster includes:
a housing;
a weight sensor; and
an acceleration sensor.

12. A system for monitoring usage of a plurality of furniture components, the system comprising:
a gateway communications module disposed in an area in proximity to the furniture components;
a plurality of casters, with each caster being associated with a different furniture component;
each one of said casters including an electronic component for sensing at least one of weight or motion of the caster, the caster being used to at least partially support its associated said furniture component;
each one of the casters further including a wireless electronic radio for wirelessly communicating with the gateway communication module and providing information concerning occupancy of its associated said furniture component; and
a cloud based remote management system configured to receive information from the gateway communications module in real time and to use the information to determine if the furniture component associated with the caster is in use; and
a central management/monitoring system in communication with the remote management subsystem for receiving information from the remote management subsystem as to a real time status of use of the furniture component.

13. The system of claim 12, the system of claim 12, wherein each said caster further includes:
a user interface;
a processor;
a battery; and
a memory.

14. The system of claim 13, wherein each said caster further includes a weight sensor.

15. The system of claim 13, wherein each said caster further includes an acceleration sensor.

16. The system of claim 12, further comprising a cloud based database in communication with the cloud based management system, the cloud based database including at least one of names, identification codes or algorithms for use in analyzing and interpreting the information received by the management system from the gateway communications module.

17. The system of claim 12, wherein the cloud based management system comprises a server, and wherein the server includes an application programming interface (API) for interpreting and managing real time data generated from the information received from the gateway communications module.

18. The system of claim 12, further comprising a cloud based notification system in communication with the cloud based management system, the cloud based notification system configured to analyze information received by the cloud based management system and provide alerts to the central management system concerning events relating to use of the furniture component associated with each one of said casters.

19. The system of claim 12, wherein the central management/monitoring system generates at least one of graphical or spreadsheet information for display on a display system.

20. A method for monitoring usage of a furniture component, the method comprising:
providing a gateway communications module disposed in proximity to the furniture component;
using a caster to at least partially support the furniture component;
configuring the caster to include an electronic component within a housing of the caster for sensing at least one of weight or motion of the caster in real time;
using a wireless electronic radio disposed in the housing of the caster for wirelessly communicating with the remote gateway communications module; and
using a remote management system configured to receive information from the gateway communications module in real time, and to use the information to determine if the furniture component associated with the caster is in use; and
using a central management/monitoring system in communication with the remote management subsystem for receiving information from the remote management subsystem as to a real time status of use of the furniture component.
